(19) United States
(12) Patent Application Publication
(10) Pub. No.: US 2017/0234468 A1
(43) Pub. Date: Aug. 17, 2017

(54) CONNECTION MECHANISM BETWEEN VALVE AND JOINT

(71) Applicant: NITTA CORPORATION, Osaka-shi, Osaka (JP)

(72) Inventor: Yasuaki TANIGUCHI, Nabari-shi, Mie (JP)

(73) Assignee: NITTA CORPORATION, Osaka-shi, Osaka (JP)

(21) Appl. No.: 15/518,972

(22) PCT Filed: Sep. 14, 2015
(86) PCT No.: PCT/JP2015/076031

§ 371 Date: Apr. 13, 2017

(30) Foreign Application Priority Data
Oct. 24, 2014 (JP) 2014-217061

(51) Int. Cl. F16L 37/084; F16K 27/00

(52) U.S. Cl. CPC F16L 37/084; F16K 27/00

(57) ABSTRACT

Provided is a connection mechanism between a valve and a joint configured to connect a tube through the joint 1 to a housing 2 of the valve in air piping. The housing 2 of the valve includes a connection hole 22 configured to accept insertion and connection of the joint 1. The connection hole 22 includes a snap ring fitting groove 23 on an inner peripheral surface thereof. The joint 1 includes a snap ring receiving groove 31 on an outer peripheral surface thereof. In an inserted state of the joint 1 into the housing 2, a snap ring 3 in the receiving groove 31 is being fitted into the fitting groove 23.

### TECHNICAL FIELD

The present invention relates to a connection mechanism between a valve and a joint in air piping, for example, air brake piping for a vehicle, such as a truck.

### BACKGROUND ART

For example, a large truck is configured to use air in order to control and drive a brake and accessories, and use a number of valves, tanks, air actuators, or the like. Conventionally, a pipe joint that connects air piping to permit passage of air is configured to fasten a valve and a joint by a tapered screw. Taking into consideration sealing properties, durability, and heat resistance, individual screws are manufactured using a metal, such as iron, brass, stainless steel, and aluminum.

FIG. 4 shows a conventional connection mechanism between a valve and a joint. A housing 20 of a metal valve is provided with a screw hole 220 having a tapered screw on an inner peripheral surface thereof. Connection is made by screwing a male screw part 120 disposed on a metal joint 10 into the screw hole 220.

Meanwhile, there is a desire to manufacture the valve and the joint by using a resin instead of a metal for the purpose of lightweighting and cost saving. However, the resin has lower creep properties than the metal, and it is therefore difficult to retain airtightness over a long term.

Although it has been known to make connection using a gasket or O-ring by applying a parallel screw, such a metric screw and a general purpose screw, to a connection part, there is a likelihood that a resin screw could become loose due to vibration or the like during use. When the joint has an L-type elbow shape, it is necessary to have a mechanism for permitting rotation of a joint body part and a screw part (a swivel structure) in order to direct the joint in any direction. This leads to a complicated and expensive structure.

### PRIOR ART

### Patent Document

Patent Document 1: Japanese Unexamined Patent Publication No. 2001-280559

### SUMMARY OF THE INVENTION

### Problems to be Solved by the Invention

A major object of the present invention is to provide a connection mechanism between a valve and a joint, which is free from problems, such as deterioration of airtightness and loosening of the connection part.

Another object of the present invention is to provide a connection mechanism between a valve and a joint which is capable of rotating the joint in any direction without employing the swivel structure even when the joint has an elbow shape.

### Means for Solving the Problems

A connection mechanism between a valve and a joint according to the present invention is configured to connect a tube through the joint to a housing of the valve in air piping. The housing of the valve includes a connection hole configured to accept insertion and connection of the joint. The connection hole includes a snap ring fitting groove on an inner peripheral surface thereof. The joint includes a snap ring receiving groove on an outer peripheral surface thereof. In an inserted state of the joint into the housing, a snap ring in the receiving groove is being fitted into the fitting groove.

### Effect of the Invention

With the present invention, the connection between the valve and the joint is not made by a screwing structure as in a conventional manner, but made in such a manner that the joint is locked to the housing of the valve by the snap ring. This eliminates the likelihood of loosening due to vibration or the like, and airtightness is retainable. The present invention, employing the above connection mechanism, makes it possible to use a resin instead of a metal for one or both of the housing of the valve and the joint, thus leading to lightweighting and cost saving.

Additionally, with the above connection mechanism of the present invention, it is possible to rotate the piping in any direction even for an elbow-shaped joint without employing the swivel structure.

### BRIEF DESCRIPTION OF THE DRAWINGS

FIG. 1 is a partially cut-away explanatory drawing that shows a state before connection in an embodiment of the present invention;

FIG. 2 is a partially cut-away explanatory drawing that shows a state after connection in the embodiment of the present invention;

FIG. 3 is a side view that shows an example of an elbow-shaped joint; and

FIG. 4 is an explanatory drawing that shows a conventional connection mechanism between a valve and a joint.

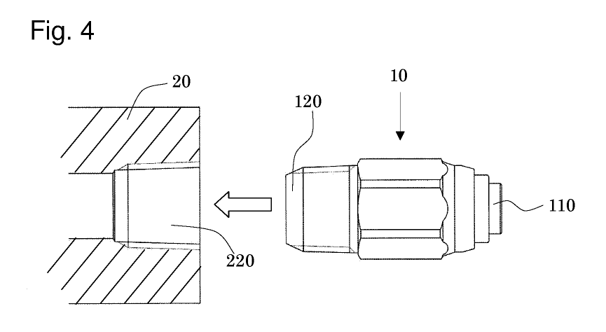

### PREFERRED EMBODIMENTS FOR CARRYING OUT THE INVENTION

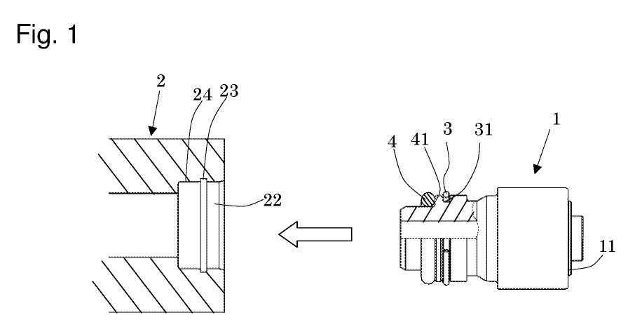

A connection mechanism of the present invention is described below with reference to the drawings. As shown in FIG. 1, the connection mechanism according to an embodiment of the present invention is configured to connect a joint 1 and a housing 2 of a valve in air piping for a truck or the like.

The joint 1 has a circumferentially extending snap ring receiving groove 31 formed on a front-side outer peripheral surface configured to be inserted into the housing 2. A step part 41 is formed ahead of the snap ring receiving groove 31, so that a front end part thereof has a smaller diameter at a front end part thereof. An O-ring 4 is configured to be attached to the step part 41 with the smaller diameter. A tube connection port 11 is formed on a rear end surface of the joint 1. The O-ring 4 has a function to seal the valve and the joint 1.

The housing 2 of the valve is provided with a connection hole 22 configured to accept insertion and connection of the joint 1, and air flows through the connection hole 22. A snap ring fitting groove 23 corresponding to the snap ring receiving groove 31 of the joint 1 is disposed on an inner peripheral surface of the housing 2. A step part 24 configured to lock the O-ring 4 is disposed more inward than the snap ring fitting groove 23.

A snap ring 3 is also referred to as a retaining ring, and a part of the snap ring 3 protrudes outward beyond the snap ring receiving groove 31. The protruded part is deformed so as to be accommodated in the snap ring fitting groove 23, and is then restored by a spring action. Examples of the snap ring 3 include an eccentric type whose width is narrowed toward a front end thereof, an elliptical shaped concentric type whose width is constant, and a spiral ring type. Any type of snap ring is usable in the present invention. Although a stainless steel wire for springs (SUS304-WPB) is usually used for the snap ring, other metals or resins are also usable.

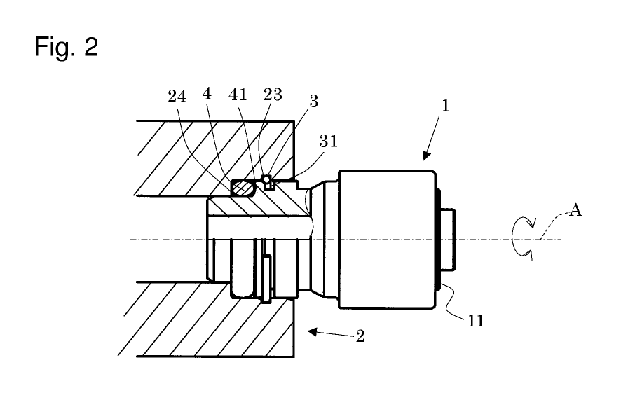

When connecting the joint 1 to the housing 2, the joint 1 is press-inserted into the connection hole 22 of the housing 2. On this occasion, the snap ring 3 in the snap ring receiving groove 31 is subjected to a diameter reduction, and the snap ring 3 is restored in the snap ring fitting groove 23 within the connection hole 22, thereby making connection to the joint 1 and the housing 2 of the valve. A connection state is shown in FIG. 2.

As shown in FIG. 2, the O-ring 4 is held between the step part 24 of the housing 2 and the step part 41 of the joint 1, and retains airtightness by sealing between the housing 2 and the joint 1.

That is, in the connection state, even though the joint 1 is rotatable around a central axis A, the joint 1 is surely sealed by the O-ring 4 and disengagement thereof from the housing 2 is preventable by the snap ring 3, and there is no likelihood of loosening due to vibration as in conventional screwing.

The present invention employs the above connection structure and hence makes it possible to use, besides metals, resins as a material of the joint 1 and the housing 2 of the valve. That is, even though the joint 1 and the housing 2 of the valve are made of a metal or resin, at least one of the two is preferably made of a resin in view of lightweighting and cost saving. A usable resin preferably satisfies heat resistance, pressure resistance, and chemical resistance that are needed for the air piping for the trucks. Examples of the resin having high heat resistance include polyphthalamide (PPA), polyhexamethylene terephthalamide (PA6T), polynonamethylene terephthalamide (PA9T), polydecamethylene terephthalamide (PA10T), polyundecamethylene terephthalamide (PA11T), poly(meta-xylyleneadipamide) (PAMXD6), polyphenylene sulfide (PPS), syndiotactic polystyrene (SPS), polycaproamide (PA6), polyhexamethylene adipamide (PA66), polyundecanamide (PA 11), and polydodecanamide (PA12). Examples of usable metals include aluminum, iron, and copper.

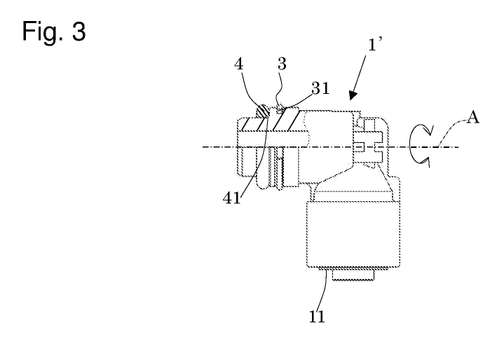

FIG. 3 shows an elbow-shaped joint 1′. Also when connecting the joint 1′, the snap ring receiving groove 31 and the step part 41 that are similar to those described above are disposed at an insertion portion into the housing 2, the snap ring 3 is configured to be fitted into the snap ring fitting groove 23, and the O-ring 4 is configured to be attached to the step part 41. Therefore, similarly to the above, the joint 1′ is press-fitted into the housing 2 so as to be fixed and connected by the snap ring 3. On this occasion, the joint 1′ is rotatable around the central axis A, and it is therefore possible to optionally change the direction of the tube connection port 11. The rest is the same as that in the foregoing embodiment.

As described above, the connection mechanism of the present invention is capable of simply and surely connecting the joint and the valve by the snap ring without using a screw structure for the joint as in a conventional manner, thereby making it possible to retain sealing properties by the O-ring or the like over a long term. It is also possible to achieve lightweighting and cost saving because the resin is usable as the material of the joint and/or the housing of the valve.

### INDUSTRIAL APPLICABILITY

There is no likelihood that loosening can occur in the connection part between the valve and the joint due to vibration or the like, and airtightness is retainable over a long term. Therefore, the connection mechanism between the valve and the joint is suitably applicable to the connection between the valve and the joint in the air piping, such as air valves, air tanks, air actuators for use in trucks and other various kinds of machines. Particularly, it is possible to contribute to the lightweighting and cost saving of the trucks or the like by using a resin instead of a metal for one or both of the housing of the valve and the joint.

### DESCRIPTION OF THE REFERENCE NUMERAL

1, 1′, 10 joint

2, 20 housing

3 snap ring

4 O-ring

11, 110 tube connection port

22 connection hole

23 snap ring fitting groove

24 step part

31 snap ring receiving groove

41 step part

1. A connection mechanism between a valve and a joint configured to connect a tube through the joint to a housing of the valve in air piping,
wherein the housing of the valve comprises a connection hole configured to accept insertion and connection of the joint, and the connection hole comprises a snap ring fitting groove provided on an inner peripheral surface thereof, and
wherein the joint comprises a snap ring receiving groove provided on an outer peripheral surface thereof, and in an inserted state of the joint into the housing, a snap ring in the receiving groove is being fitted into the fitting groove.

2. The connection mechanism according to claim 1, wherein the joint has an elbow shape.

3. The connection mechanism according to claim 1, wherein the joint comprises an O-ring being attached to the outer peripheral surface.

4. The connection mechanism according to claim 1, wherein at least one of the housing of the valve and the joint is made of a resin.
